(19) United States
(12) Patent Application Publication
(10) Pub. No.: US 2022/0057978 A1
(43) Pub. Date: Feb. 24, 2022

(54) Display Method And Apparatus, Intelligent Wearable Device, And Storage Medium

(71) Applicant: Anhui Huami Information Technology Co., Ltd., Hefei (CN)

(72) Inventors: Wang Huang, Hefei (CN); Pengtao Yu, Hefei (CN); Kongqiao Wang, Hefei (CN)

(21) Appl. No.: 17/520,081

(22) Filed: Nov. 5, 2021

Related U.S. Application Data
(63) Continuation of application No. PCT/CN2020/089205, filed on May 8, 2020.

(30) Foreign Application Priority Data
May 8, 2019 (CN) 201910380344.2

(51) Int. Cl. G06F 3/14; G06F 3/0488; G06F 3/16; G06F 3/01; G06F 3/0346; G06F 1/16

(52) U.S. Cl. CPC G06F 3/14; G06F 3/04886; G06F 3/16; G06F 3/0485; G06F 3/0346; G06F 1/163; G06F 3/015

(57) ABSTRACT

A display method and apparatus, a wearable device, and a computer-readable storage medium are provided. The method is applied to the wearable device. The wearable device comprises at least two touchable screen display areas. The method comprises: displaying current content on a lightened screen display area; and adjusting the current content displayed on the lightened screen display area according to a touch event on another non-lightened screen display area. The reading and interaction processes of users do not conflict with each other.

CROSS-REFERENCE TO RELATED APPLICATION(S)

The present application is a continuation of International (PCT) Patent Application No. PT/CN2020/089205 filed May 8, 2020 which claims priority to Chinese Patent Application No. 201910380344.2 filed May 8, 2019, the contents of both of which are hereby incorporated by reference in their entireties.

### TECHNICAL FIELD

The present disclosure relates to the technical field of wearable devices, and in particular, to a display method and apparatus, a wearable device, and a computer-readable storage medium.

### BACKGROUND

With the development of wearable technologies, wearable devices, such as bracelets, watches, armbands, or wristbands, are playing an increasingly important role in people's mobile lifestyle, and the consequent demand for “reversed transmission of the pressure” is also vigorously promoting further development of wearable technology. This is reflected not only in new sensor technologies and biometric algorithms, but also in the interaction between users and wearable devices.

From an application point of view, wearable devices are currently mainly used in subdivided fields such as sports and health. In addition, there is a growing demand for wearable devices with communication functions in the mobile market recently.

However, in the process of implementing the embodiments of the present disclosure, whether used for sports and health, or for communications, compared with the interaction process between a mobile phone and a user, the wearable device lacks the size of the interactive interface. That is, the screen of the wearable device is too small, and when the user directly touches or taps such a small screen for interaction with a finger, the finger blocks a large potion (sometimes at least a quarter) of the information on the screen, making the interaction difficult and inefficient.

### SUMMARY

The present disclosure provides a display method and apparatus, a wearable device, and a computer-readable storage medium.

According to a first aspect of the embodiments of the present disclosure, a display method is provided, wherein the display method is applied to a wearable device, and the wearable device includes at least two touchable screen display areas. The display method also includes displaying current content on a first screen display area that has been turned on. The display method also includes adjusting the current content displayed on the first screen display area according to a touch event on a second screen display area that has not been turned on, where the at least two touch screen display areas include the first screen display area and the second screen display area. Optionally, positions of the screen display areas satisfy that: when a user wears the wearable device, the screen display areas are not located on the same plane at the same time.

Optionally, the display method where positions of the first screen display area and the second screen display area satisfy that: when a user wears the wearable device, the first screen display area and the second screen display area are not located on the same plane simultaneously.

Optionally, the wearable device further includes an inertial sensor; and where the display method further includes: before turning on the first screen display area: determining a target action of the user according to data collected by the inertial sensor; and determining a screen display area from the at least two touch screen display areas as the first screen display area to be turned on corresponding to a sight range of the user according to the target action.

Optionally, the display method further including: determining a display direction of the current content according to the target action, and adjusting the current content based on the display direction, the display direction being a horizontal direction or a vertical direction.

Optionally, the wearable device further includes an electromyography sensor; where the display method further includes: after turning on the first screen display area, when the data collected by the electromyography sensor meets a preset condition, turning on a corresponding screen display area, the preset condition including data representing that a current action of the user is a clenching action.

Optionally, the wearable device further includes at least two audio collection units corresponding to the at least two touch screen display areas; and where the display method further includes: before turning on the first screen display area, determining an audio collection unit nearest to a sound source according to voice signals collected by all the at least two audio collection units, so as to determine a corresponding screen display area as the first screen display area to be turned on.

Optionally, the display method further includes: in case a designated action of the user is detected, turning on all the screen display areas to display the current content together.

Optionally, the display method further including: when the first screen display area is turned on, activating the second screen display area that has not been turned on.

Optionally, the display method further including: when multiple touch events are received, processing the multiple touch events in sequence based on preset touch event response priorities of the at least two touch screen display areas, so as to adjust the current content displayed on the first screen display area, the touch events including events triggered on all of the at least two touch screen display areas.

Optionally, the touch event includes at least one of: a sliding event, a tap event, or a long press event.

Optionally, the adjusting the current content displayed on the first screen display area includes: controlling scrolling of the content displayed on the first screen display area; or switching the content displayed on the first screen display area.

According to a second aspect of the embodiments of the present disclosure, an wearable device is provided. The wearable device includes: a processor; a storage configured to store instructions executable by the processor; and at least two touchable screen display areas; where the processor is configured to perform the display method.

Optionally, positions of the first screen display area and the second screen display area satisfy that: when a user wears the wearable device, the first screen display area and the second screen display area are not located on the same plane simultaneously.

Optionally, the wearable device further includes an inertial sensor; and where the display method further includes: before turning on the first screen display area: determining a target action of the user according to data collected by the inertial sensor; and determining a screen display area from the at least two touch screen display areas as the first screen display area to be turned on corresponding to a sight range of the user according to the target action.

Optionally, the wearable device further includes an electromyography sensor; where the display method further includes: after turning on the first screen display area, when the data collected by the electromyography sensor meets a preset condition, turning on a corresponding screen display area, the preset condition including data representing that a current action of the user is a clenching action.

Optionally, the wearable device further includes at least two audio collection units corresponding to the at least two touch screen display areas; and where the display method further includes: before turning on the first screen display area, determining an audio collection unit nearest to a sound source according to voice signals collected by all the at least two audio collection units, so as to determine a corresponding screen display area as the first screen display area to be turned on.

Optionally, the wearable device further including: when the first screen display area is turned on, activating the second screen display area that has not been turned on. Optionally, the wearable device further including: when multiple touch events are received, processing the multiple touch events in sequence based on preset touch event response priorities of the at least two touch screen display areas, so as to adjust the current content displayed on the first screen display area, the touch events including events triggered on all of the at least two touch screen display areas.

According to a third aspect of the embodiments of the present disclosure, a non-transitory computer-readable storage medium having a computer program stored thereon, which, when executed by one or more processors, causes the processors to perform the display method.

Optionally, positions of the first screen display area and the second screen display area satisfy that: when a user wears the wearable device, the first screen display area and the second screen display area are not located on the same plane simultaneously; where the wearable device further includes an inertial sensor; and where the display method further includes: before turning on the first screen display area: determining a target action of the user according to data collected by the inertial sensor; and determining a screen display area from the at least two touch screen display areas as the first screen display area to be turned on corresponding to a sight range of the user according to the target action. Implementations of the described techniques may include hardware, a method or process, or computer software on a computer-accessible medium.

The technical solutions provided in the embodiments of the present disclosure may include the following beneficial effects:

In the present disclosure, the wearable device is provided with at least two touchable screen display areas, the current content is displayed on the lightened screen display area, and when a touch event on another non-lightened screen display area is detected, the current content displayed on the lightened screen display area is adjusted accordingly based on the touch event. In the embodiments of the present disclosure, the information that the user needs to read is only displayed on the lightened screen display area, other non-lightened screen display areas are used as an input area for interaction commands, so that the reading and interaction processes of the user do not conflict with each other. While reading the content, a corresponding content adjustment operation can also be performed, thereby facilitating the use of the user and helping to improve the use experience of the user.

It should be understood that the foregoing general description and the following detailed description are merely example and explanatory, and are not intended to limit the present disclosure.

### BRIEF DESCRIPTION OF DRAWINGS

The accompanying drawings here, which are incorporated into the specification and constitute a part of the specification, illustrate embodiments that conform to the present disclosure and are used together with the specification to explain the principles of the present disclosure.

FIG. 1 is a schematic diagram of a wearable device including two screen display areas according to an example embodiment of the present disclosure.

FIG. 2 is a flowchart of a display method according to an example embodiment of the present disclosure.

FIG. 3 is a flowchart of a screen display area corresponding to a sight range of a user after a wrist turning or raising action according to an example embodiment of the present disclosure.

FIG. 4 is a schematic diagram of a wearable device including two screen display areas and two corresponding audio collection units according to an example embodiment of the present disclosure.

FIG. 5 is a flowchart of another display method according to an example embodiment of the present disclosure.

FIG. 6 is a third flowchart of a display method according to an example embodiment of the present disclosure.

FIG. 7 is a schematic diagram of changing a content display direction when a user wears the wearable device and turns the wrist according to an example embodiment of the present disclosure.

FIG. 8 is an example schematic diagram of orientations of a three-dimensional coordinate system according to an example embodiment of the present disclosure.

FIG. 9 is a structural block diagram of a display apparatus according to an example embodiment of the present disclosure.

FIG. 10 is a structural block diagram of another display apparatus according to an example embodiment of the present disclosure.

FIG. 11 is an architecture diagram of a wearable device according to an example embodiment of the present disclosure.

### DETAILED DESCRIPTION

Example embodiments will be described here in detail, and examples thereof are represented in the accompanying drawings. When the following description relates to the accompanying drawings, unless otherwise indicated, the same numbers in different accompanying drawings represent the same or similar s. The implementations described in the following example embodiments do not represent all implementations consistent with the present disclosure. Conversely, they are merely examples of apparatuses and methods consistent with some aspects of the present disclosure as detailed in the appended claims.

Terms used in the present disclosure are merely for describing specific embodiments and are not intended to limit the present disclosure. The singular forms “a”, “said”, and “the” used in the present application and the appended claims are intended to include the plural form, unless the context clearly indicates otherwise. It should also be understood that the term “and/or” used herein refers to and includes any or all possible combinations of one or more associated listed terms.

It should be understood that although terms “first,” “second,” “third,” and the like may be used in the present disclosure to describe various information, the information should not be limited to these terms. These terms are only used for distinguishing information of the same type. For example, without departing from the scope of the present disclosure, first information may also be referred to as second information, and similarly the second information may also be referred to as the first information. Depending on the context, for example, the term “if” used herein may be explained as “when” or “while”, or “in response to a determination.”

Whether used for sports and health, or for communications, compared with the interaction process between a mobile phone and a user, the wearable device in the related art has a serious shortcoming in the size of the interactive interface. That is, the screen of the wearable device is too small, and when the user directly touches or taps such a small screen for interaction with a finger, the finger blocks at least a quarter of the information on the screen, making the interaction difficult and inefficient

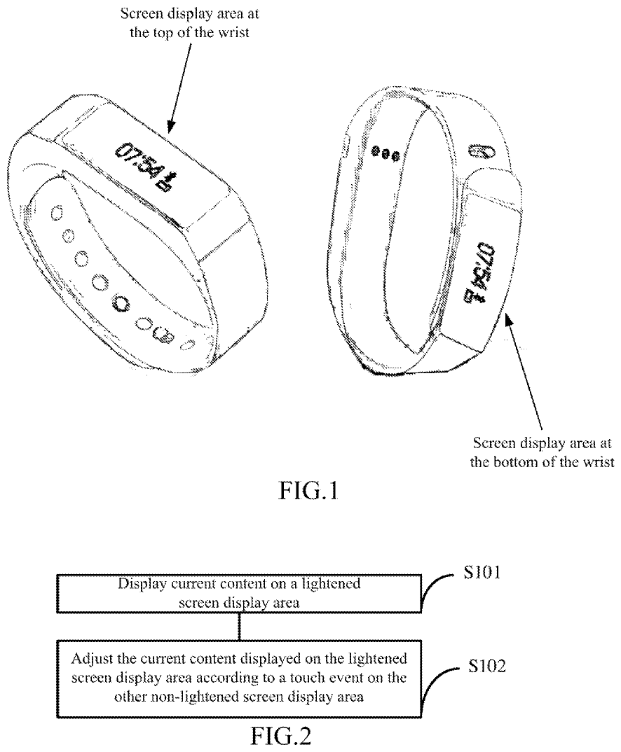

Therefore, to solve the problems in the related art, the embodiments of the present disclosure provide a display method. The display method in the embodiments of the present disclosure can be applied to a wearable device. The wearable device may be a bracelet, a watch, a wristband, a finger ring, an armband, or an ankle ring, etc. The wearable device includes at least two touchable screen display areas. Specifically, each screen display area may be an independent display screen, and the wearable device includes a screen consisting of at least two independent display screens and having multiple display areas. Alternatively, the wearable device includes a display screen, and the display screen may include multiple display areas. In an example, referring to FIG. 1, the two screen display areas included in the wearable device (taking a wristband as an example for presentation and description in FIG. 1) are two independent display screens. When the user wears the wearable device, one of the screen display areas is located at the top of the wrist, and the other screen display area is located at the bottom of the wrist. It can be understood that the embodiments of the present disclosure do not impose any limitations to the number of the screen display areas, which can be specifically set according to actual situations. In addition, the screen material of the screen display areas may be a flexible touch screen material with expandability and bendability.

Referring to FIG. 2, FIG. 2 is a flowchart of a display method according to an example embodiment of the present disclosure. The method includes the following steps.

In step S101, current content is displayed on a lightened screen display area, which is a first screen display area that has been turned on.

In step S102, the current content displayed on the lightened screen display area is adjusted according to a touch event on another non-lightened screen display area, which is a second screen display area that has not been turned on.

In the embodiments of the present disclosure, the current content is displayed on the lightened screen display area, and when a touch event on another non-lightened screen display area is detected, the current content displayed on the lightened screen display area is adjusted accordingly based on the touch event. That is, the information that the user needs to read is only displayed on the lightened screen display area, other non-lightened screen display areas are used as an input area for interaction commands, so that the reading and interaction processes of the user do not conflict with each other. While reading the content, a corresponding content adjustment operation can also be performed, thereby facilitating the use of the user and helping to improve the use experience of the user.

It should be noted that, to reduce cumbersome operations of manually adjusting the screen display areas to be within a sight range before the user wants to turn on the wearable device for certain operations, the positions of the screen display areas in the embodiments of the present disclosure are set to satisfy the following condition: when the user wears the wearable device, the screen display areas are not located on the same plane at the same time. In an example, the wearable device (such as a bracelet, also referred to as a wristband) includes a display screen. The display screen includes three screen display areas. When the user wears the wearable device, one of the screen display areas is located at the top of the wrist, the second screen display area is located at the front of the wrist, and the third screen display area is located at the bottom of the wrist, thereby ensuring that no matter from which angle the user wants to turn on the wearable device, there is always a screen display area within the sight range of the user, thus avoiding the cumbersome operations that the user needs to manually adjust the screen display area, and improving the use experience of the user.

For step S101, after determining at least one screen display area to be turned on, the wearable device turns on the screen display area to display the current content, for example, displaying a menu interface, or an interface opened by the user last time, or a display interface preset by the user, such as a clock display interface, a weather display interface, and a sports parameter display interface.

The process of determining the at least one screen display area to be turned on may include, but is not limited to, the following implementations.

In a first implementation, the wearable device further includes an inertial sensor. The inertial sensor is configured to detect and measure acceleration, tilt, shock, vibration, rotation, and multi-degree of freedom (DoF) motion. The inertial sensor includes an accelerometer (or an acceleration sensor) and an angular velocity sensor (a gyro) and their single-, dual-, and three-axis combined inertial measurement unit (IMU). It can be understood that the present disclosure does not impose any limitations to the specific type and model of the inertial sensor, which can be specifically set according to actual situations. The wearable device can determine a target action of the user according to data collected by the inertial sensor, and then determine a screen display area to be turned on corresponding to the sight range of the user according to the target action. The data collected by the inertial sensor includes three-axis acceleration data and angular velocity data in a three-dimensional coordinate system. It should be noted that in this embodiment, the direction facing up relative to the ground is defined as the direction corresponding to the sight range of the user, the screen display area facing up relative to the ground is determined as the screen display area corresponding to the sight range of the user. The embodiments of the present disclosure realize automatic sensing of the sight range of the user, without requiring the user to manually adjust the screen position, thereby further improving the user experience of the user.

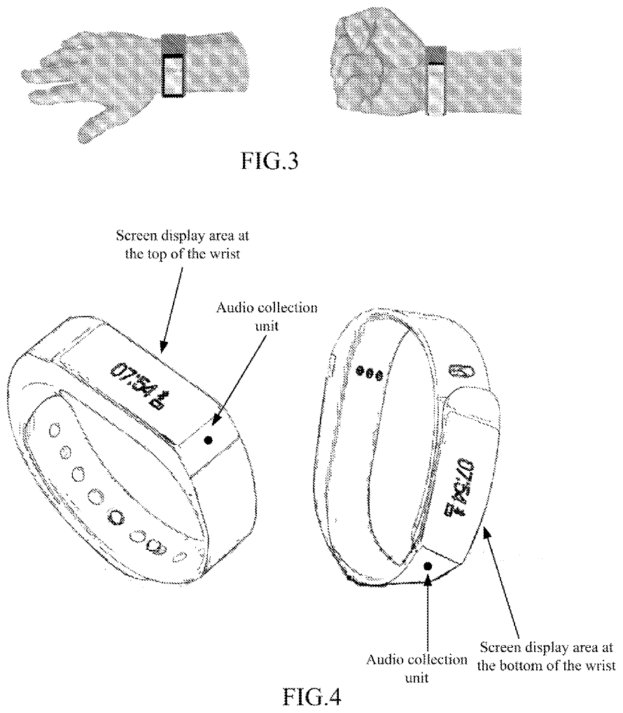

In an example, referring to FIG. 3, the wearable device can be worn on the wrist, and the target action may be a wrist raising action. The wearable device can obtain a wrist raising action of the user according to the acceleration data in the three axis directions in the three-dimensional coordinate system measured by the inertial sensor, and then determines the direction of the wrist raising action according to Z-axis acceleration data, so as to determine the screen display area to be turned on corresponding to the sight range of the user. For example, the wearable device includes two independent screen display areas. When the user wears the wearable device, one of the screen display areas is located at the top of the wrist, and the other screen display area is located at the bottom of the wrist. When it is determined that the user performs a wrist raising action and the back of the hand faces up after the wrist is raised, the screen display area located at the top of the wrist is determined to face up, and is determined as the screen display area to be turned on corresponding to the sight range of the user. When it is determined that the user performs a wrist raising action and the palm of the hand faces up after the wrist is raised, the screen display area located at the bottom of the wrist is determined to face up, and is determined as the screen display area to be turned on corresponding to the sight range of the user.

In another example, referring to FIG. 3, the wearable device can be worn on the wrist, and the target action may be a wrist turnover action. The wearable device can obtain the wrist turnover action of the user based on X-axis angular velocity data in the three-dimensional coordinate system measured by the inertial sensor, and then determine the turnover direction of the wrist turnover action according to Z-axis acceleration data, so as to determine the screen display area to be turned on corresponding to the sight range of the user. For example, the wearable device includes two screen display areas. When the user wears the wearable device, one of the screen display areas is located at the top of the wrist, and the other screen display area is located at the bottom of the wrist. When it is determined that the user performs a wrist turnover action of turning from the back of the hand up to the palm of the hand up, the screen display area located at the bottom of the wrist is determined to face up, and is determined as the screen display area to be turned on corresponding to the sight range of the user. When it is determined that the user performs a wrist turnover action of turning from the palm of the hand up to the back of the hand up, the screen display area located at the top of the wrist is determined to face up, and is determined as the screen display area to be turned on corresponding to the sight range of the user.

In a second possible implementation, the wearable device includes at least two audio collection units. The screen display areas correspond one-to-one to the audio collection units. The audio collection units may be arranged around the screen display areas. In an example, referring to FIG. 4, taking the wearable device being a wristband as an example for description, for example, the audio collection units can be disposed at any positions that are not greater than a preset distance threshold, such as 1 cm, 1.1 cm, or 1.2 cm, from the screen display areas, or the audio collection units can be disposed on side edges of the wristband corresponding to the screen display areas (planes other than the upper and lower surfaces of the wristband). It can be understood that the embodiments of the present disclosure do not impose any limitations to the specific types of the audio collection apparatuses, which can be specifically set according to actual situations. For example, the audio collection units may be microphones or pick-ups. The wearable device determines an audio collection unit nearest to a sound source according to voice signals collected by all the audio collection units, so as to determine the corresponding screen display area to be turned on. The embodiments of the present disclosure realize a process of automatically turning on a screen by sensing the orientation of a user based on sound, without requiring the user to manually adjust the screen position, thereby further improving the use experience of the user.

In a possible implementation, the wearable device can respectively calculate a preset parameter of the voice signal collected by each audio collection unit. The preset parameter may be a parameter related to the energy of the voice signal or a parameter related to the amplitude of the voice signal. The wearable device can then determine the audio collection unit nearest to the sound source according to the preset parameter. For example, the wearable device can convert the voice signals collected by the audio collection units into electrical signals, and then calculate the energy of the voice signals based on the amplitudes sampled from the electrical signals. After obtaining the energy of the voice signal collected by each audio collection unit, the wearable device can determine the audio collection unit nearest to the sound source according to the magnitude relationship of the energy, e.g., determining the audio collection unit with the largest energy as the audio collection unit nearest to the sound source.

In an example, after determining the screen display area to be turned on, the wearable device can directly turn on the corresponding screen display area to display the current content.

In another embodiment, to further improve the accuracy of recognition, the wearable device may further be provided with an electromyography sensor. After determining the screen display area to be turned on, the wearable device can determine whether to turn on the corresponding screen display area according to the data collected by the electromyography sensor. For example, when the wearable device is worn on an upper limb, it is detected that the data collected by the electromyography sensor meets a preset condition. The preset condition includes relevant data representing that the current action of the user is a clenching action. The wearable device then determines to turn on the corresponding screen display area, thereby avoiding the occurrence of accidental lighting phenomenon, and improving the user experience of the user.

Certainly, it can be understood that the wearable device can also set a corresponding lightening key for the screen display area in advance. The lightening key may be a virtual key or a physical key, and the embodiments of the present disclosure do not impose any limitations thereto. During use, if the wearable device detects a trigger operation for the lightening key, the wearable device turns on the screen display area corresponding to the lightening key, thereby meeting the lightening needs of the user. In an example, it should be noted that, while determining at least one screen display area to be turned on and turning on the screen display area, the wearable device activates the other non-lightened screen display area, so that the other non-lightened screen display area is converted from a dormant state to a detection state, and thus can detect and respond to touch events.

It should be noted that, before the wearable device turns on any screen display area, that is, when all the screen display areas are off, all the screen display areas are in a dormant state, and the wearable device does not respond to any touch event on the screen display areas. Only after the wearable device determines at least one screen display area to be turned on based on the foregoing implementations and turns on the screen display area, the wearable device responds to the touch events on the screen display area.

For step S102, when detecting a touch event on the non-lightened screen display area, the wearable device can generate a display instruction based on the touch event, and then adjust the current content displayed on the lightened screen display area according to the display instruction. The touch event may be a sliding event, a press event, a tap event, or a long press event, etc. The adjusting the current content displayed on the lightened screen display area may be controlling the scrolling of the content displayed on the lightened screen display area, or switching the content displayed on the lightened screen display area, or selecting, editing or moving the currently displayed content. In an example, for example, if a single-finger sliding operation of a user on the non-lightened screen display area is detected, the wearable device can, based on the single-finger sliding operation, correspondingly control the scrolling of the content displayed on the lightened screen display area, and based on the direction of the single-finger sliding, correspondingly control the scrolling direction (scrolling up/down) of the content displayed on the lightened screen display area. It can be understood that the embodiments of the present disclosure do not impose any limitations to the correspondence between the sliding direction and the scrolling direction, which can be specifically set according to actual situations. In another example, for example, if a two-finger or multi-finger open-close sliding operation (zoom gesture) of the user on the non-lightened screen display area is detected, the wearable device can zoom in or zoom out the content displayed on the lightened screen display area based on the open-close sliding operation. According to the embodiments of the present disclosure, while reading the content, a corresponding content adjustment operation can also be performed, thereby facilitating the use of the user and helping to improve the use experience of the user.

In a possible implementation, because some users are accustomed to perform touch operations on a screen display area where contents are displayed, in the embodiments of the present disclosure, the lightened screen display area can also detect and respond to the touch event of the user, thereby facilitating the use of the user.

In an embodiment, the wearable device can preset touch event response priorities of all the screen display areas, and can thus process events that may be triggered simultaneously on all the screen display areas. It can be understood that the embodiments of the present disclosure do not impose any limitations to the setting of the touch event response priorities, which can be specifically set according to actual situations, for example, setting the touch event response priority of the non-lightened screen display area to be higher than that of the lightened screen display area. When receiving multiple touch events at the same time, the wearable device can process the multiple touch events in sequence based on the preset touch event response priorities of the screen display areas, so as to adjust the current content displayed on the lightened screen display area. Possibly, when receiving multiple touch events at the same time, the wearable device can determine by which screen display area the touch events are detected and sent, and can thus determine the processing sequence of the multiple touch events based on the preset touch event response priorities of all the screen display areas. As another possibility, the touch events include corresponding touch coordinates, then the wearable device can determine the screen display areas corresponding to the touch events based on the touch coordinates, and can thus determine the processing sequence of the multiple touch events based on the preset touch event response priorities of all the screen display areas, thereby ensuring the orderly processing of the touch events.

In another possible implementation, the lightened screen display area can also be configured to not respond to the touch events of the user, and the user can perform touch operations on the other non-lightened screen display area, so that the reading and interaction operations can be performed at the same time without affecting each other.

FIG. 5 is a second flowchart of a display method according to an example embodiment of the present disclosure. FIG. 5 describes the solution of the present disclosure in more detail relative to FIG. 2.

As shown in FIG. 5, the method can be applied to the wearable device. The wearable device includes at least two touchable screen display areas. The method includes the following steps.

In step S201, current content is displayed on a lightened screen display area, which is a first screen display area that has been turned on. This step is similar to step S101 in FIG. 2, and is not detailed herein again.

In step S202, the current content displayed on the lightened screen display area is adjusted according to a touch event on another non-lightened screen display area, which a second screen display area that has not been turned on. This step is similar to step S102 in FIG. 2, and is not detailed herein again.

In step S203, if a designated action of the user is detected, all the screen display areas are lightened to display the current content together.

For step S203, when the content displayed on the lightened screen display area cannot meet the reading needs of the user, the wearable device can perform full-screen display based on the needs of the user. Realizably, a designated operation can be preset, for example, setting a designated key area, which may be a virtual key or a physical key. The wearable device detects the designated action of the user, for example, when the user taps on the designated key area, the wearable device detects that the designated key area is triggered, and then turns on all the screen display areas to display the current content together, thereby meeting the needs of the user to view complete information.

In a possible implementation, after turning on all the screen display areas, the wearable device can determine the content during full-screen display based on the position of the currently lightened screen display area. For example, at present, the wearable device (taking a wristband as an example for description) is provided with three screen display areas. When the user wears the wearable device, the three screen display areas are respectively located at the top of the wrist, the front of the wrist, and the bottom of the wrist. If the currently lightened screen display area is the screen display area at the top of the wrist and displays partial information, when all the screen display areas are lightened, the content next to the partial information is displayed on the two screen display areas at the front of the wrist and at the bottom of the wrist in sequence. If the currently lightened screen display area is the screen display area at the front of the wrist and displays partial information, when all the screen display areas are lightened, the content preceding the partial information is displayed on the screen display area at the top of the wrist, and the content following the partial information is displayed on the screen display area at the bottom of the wrist. If the currently lightened screen display area is the screen display area at the bottom of the wrist and displays partial information, when all the screen display areas are lightened, the content preceding the partial information is displayed on the screen display area at the top of the wrist and the screen display area at the front of the wrist in sequence.

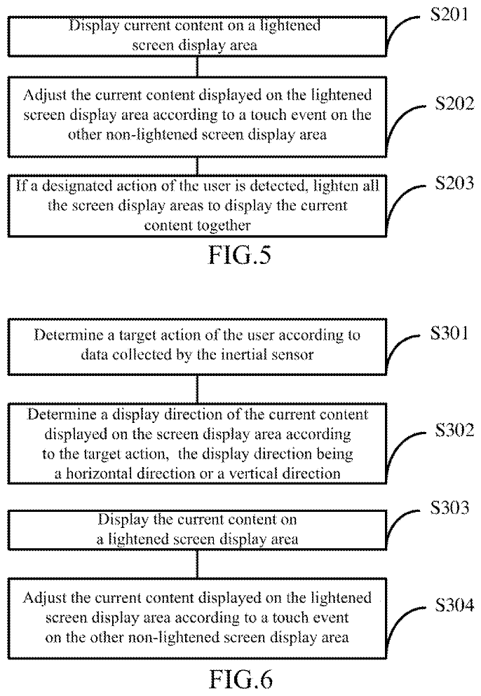

FIG. 6 is a third flowchart of a display method according to an example embodiment of the present disclosure. FIG. 6 describes the solution of the present disclosure in more detail relative to FIG. 2.

As shown in FIG. 6, the method can be applied to the wearable device. The wearable device includes at least two touchable screen display areas and an inertial sensor. The method includes the following steps.

In step S301, a target action of the user is determined according to data collected by the inertial sensor.

In step S302, a display direction of the current content displayed on a screen display area is determined according to the target action. The display direction is a horizontal direction or a vertical direction.

In step S303, the current content is displayed on a lightened screen display area, which is a first screen display area that has been turned on. This step is similar to step S101 in FIG. 2, and is not detailed herein again.

In step S304, the current content displayed on the lightened screen display area is adjusted according to a touch event on another non-lightened screen display area. This step is similar to step S102 in FIG. 2, and is not detailed herein again.

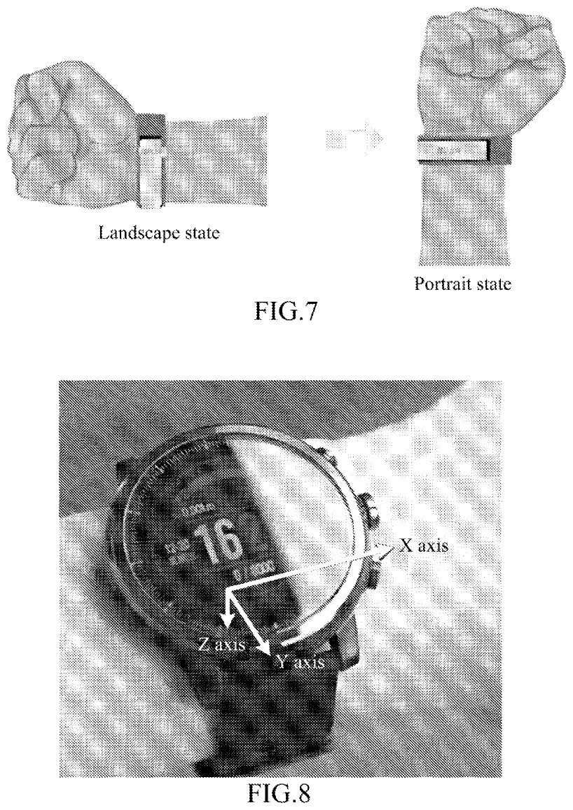

In the embodiments of the present disclosure, the display direction of the current content can be determined according to the target action of the user, and then the current content can be adjusted, to facilitate the viewing of the user. It should be noted that the target action may be a wrist turning action. The wrist turning action includes two situations. One is wrist turning in the vertical direction, that is, an arm of the user is turned from a horizontal direction parallel to the ground to a vertical direction perpendicular to the ground. The second is wrist turning in the horizontal direction, that is, the arm of the user is turned from a horizontal direction parallel to the body to a vertical direction perpendicular to the body (it should be noted that the vertical direction perpendicular to the body is not completely parallel to the ground direction, and has a certain included angle with the ground, and the angle is less than)90° . In an example, please referring to FIG. 7, after the user wears the wearable device (taking a wristband as an example for description in FIG. 7) and turns the wrist, if the arm of the user is turned from the horizontal direction parallel to the ground to the vertical direction perpendicular to the ground, or from the horizontal direction parallel to the body to the vertical direction perpendicular to the body, the wearable device adjusts the current content in the lightened screen display area to the vertical direction (portrait state). If the arm of the user is turned from the vertical direction perpendicular to the ground to the horizontal direction parallel to the ground, or from the vertical direction perpendicular to the body to the horizontal direction parallel to the body, the wearable device adjusts the current content of the lightened screen display area to the horizontal direction (landscape state).

For step S301, the wearable device can obtain the wrist turning action of the user according to Z-axis angular velocity data in a three-dimensional coordinate system measured by the inertial sensor. Specifically, the wearable device can determine whether the action is a wrist turning action by determining whether the Z-axis angular velocity data is greater than or equal to a preset threshold, and if yes, determine that the current action of the user is the wrist turning action. It can be understood that the present disclosure does not impose any limitations to the preset threshold, which can be specifically set according to actual situations.

For step S302, after determining that the target action is the wrist turning action, the wearable device can determine a turnover direction of the wrist turning action according to X-axis and Y-axis acceleration data to determine the display direction of the current content, thereby adjusting the current content according to the display direction of the current content to facilitate the reading of the user.

Specifically, the wearable device can obtain the X-axis acceleration data and the Y-axis acceleration data within a preset time period, then respectively calculate the average values of the first halves and the average values of the second halves of the X-axis acceleration data and the Y-axis acceleration data in the preset time period, and finally determine the turnover direction of the wrist turning action according to signs of the average values of the first halves and the average values of the second halves of the X-axis acceleration data and the Y-axis acceleration data, the magnitude relation between the difference between the two average values of the X-axis acceleration data and a preset threshold, and the magnitude relation between the difference between the two average values of the Y-axis acceleration data and the preset threshold. The signs of the average value of the first half and the average value of the second half of the X-axis acceleration are related to the value of an included angle formed by an X-axis direction and a direction of gravitational acceleration, and the signs of the average value of the first half and the average value of the second half of the Y-axis acceleration are related to the value of an included angle formed by a Y-axis direction and the direction of gravitational acceleration.

In an example, the user wears the wearable device. Assuming that the current direction is a horizontal direction parallel to the ground and parallel to the body, and the palm of the hand faces up, the screen display area corresponding to the sight range of the user is a screen display area at the bottom of the wrist. In this case, the screen display area at the bottom of the wrist is lightened, and the text display direction of the current content is the horizontal direction (landscape display). If the user performs a wrist turning action of turning to a vertical direction perpendicular to the ground or a vertical direction perpendicular to the body, and the palm of the hand faces up, the text display direction of the current content in the currently lightened screen display area at the bottom of the wrist is changed from the horizontal direction to the vertical direction (portrait display).

In another example, the user wears the wearable device. Assuming that the current direction is the vertical direction perpendicular to the ground and the vertical direction perpendicular to the body, and the palm of the hand faces up, the screen display area corresponding to the sight range of the user is a screen display area at the bottom of the wrist. In this case, the screen display area at the bottom of the wrist is lightened, and the text display direction of the current content is the vertical direction (portrait display). If the user performs a wrist turning action of turning to the horizontal direction parallel to the ground and parallel to the body, and the palm of the hand faces up, the text display direction of the current content in the currently lightened screen display area at the bottom of the wrist is changed from the vertical direction to the horizontal direction (landscape display).

In an example, taking the orientations of the three-dimensional coordinate system shown in FIG. 8 as an example (it should be noted that the wrist turning action is described based on the orientations of the three-dimensional coordinate system when the dial is worn on the palm of the hand in FIG. 8), and it is defined that if the directions of the X-axis and Y-axis accelerations are the same as the direction of gravitational acceleration or the included angles with the direction of gravitational acceleration are less than 90°, the acceleration data is a negative value. If the included angles with the direction of gravitational acceleration are equal to 90°, the acceleration data is 0. If the directions are opposite to the direction of gravitational acceleration or the included angles with the gravitational acceleration are greater than 90°, the following description is made: the wearable device obtains the X-axis acceleration data and the Y-axis acceleration data within a preset time period; if the average value of the first half of the X-axis acceleration data is negative, the average value of the second half is positive, and the absolute value of the difference between the two average values of the X-axis acceleration data is greater than a specified threshold, and if the average value of the first half of the Y-axis acceleration data is positive, the average value of the second half is negative, and the absolute value of the difference between the two average values of the Y-axis acceleration data is greater than the specified threshold, determines that the wrist turning action is turning to the horizontal direction parallel to the ground; and if the average value of the first half of the X-axis acceleration data is positive, the average value of the second half is negative, and the absolute value of the difference between the two average values of the X-axis acceleration data is greater than the specified threshold, and if the average value of the first half of the Y-axis acceleration data is negative, the average value of the second half is positive, and the absolute value of the difference between the two average values of the Y-axis acceleration data is greater than the specified threshold, determines that the wrist turning action is turning to the vertical direction perpendicular to the ground.

In the embodiments of the present disclosure, the display direction of the current content is determined according to the target action, so as to adjust the current content according to the display direction, which facilitates the viewing of the user and is beneficial to improving the use experience of the user. Corresponding to the embodiments of the foregoing display method, the present disclosure further provides embodiments of a display apparatus and an wearable device to which the display apparatus is applied.

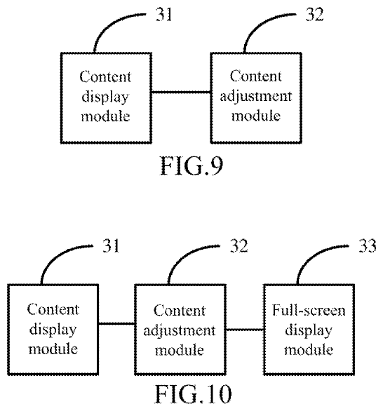

As shown in FIG. 9, FIG. 9 is a block diagram of a display apparatus according to an example embodiment of the present disclosure. The apparatus is applied to an wearable device. The wearable device includes at least two touchable screen display areas.

The display apparatus includes:

a content display module 31, configured to display current content on a lightened screen display area, which is a first screen display area that has been turned on; and

a content adjustment module 32, configured to adjust the current content displayed on the lightened screen display area according to a touch event on another non-lightened screen display area, which is a second screen display area that has not been turned on.

In an embodiment, positions of the screen display areas satisfy that: when a user wears the wearable device, the screen display areas are not located on the same plane at the same time.

In an embodiment, the wearable device further includes an inertial sensor.

The inertial sensor is configured to collect data.

The display apparatus further includes:

a target action determination module, configured to determine a target action of the user according to the data collected by the inertial sensor; and

a display area determination module, configured to determine a screen display area to be turned on corresponding to a sight range of the user according to the target action.

In an embodiment, the display apparatus further includes:

a content display direction adjustment unit, configured to determine a display direction of the current content according to the target action, and adjust the current content based on the display direction. The display direction is a horizontal direction or a vertical direction.

In an embodiment, the wearable device further includes audio collection units corresponding to the screen display areas.

The audio collection units are configured to collect voice signals.

The display area determination module is further configured to determine an audio collection unit nearest to a sound source according to the voice signals collected by all the audio collection units, so as to determine the corresponding screen display area to be turned on.

Optionally, the wearable device further includes an electromyography sensor.

The display apparatus further includes:

a screen lightening module, configured, when the display area determination module determines the screen display area to be turned on and the data collected by the electromyography sensor meets a preset condition, to lighten the corresponding screen display area. The preset condition includes relevant data representing that the current action of the user is a clenching action.

In an implementation, the display apparatus further includes:

an activation module, configured, when the screen display area is lightened, to activate the other non-lightened screen display area.

In an embodiment, the content adjustment module is further configured, when multiple touch events are received, to process the multiple touch events in sequence based on preset touch event response priorities of the screen display areas, so as to adjust the current content displayed on the lightened screen display area. The touch events include events triggered on all the screen display areas.

In an example, the touch event includes at least any one or more of: a sliding event, a tap event, or a long press event.

In an implementation, the content adjustment module includes:

a display instruction generation unit, configured to generate a display instruction according to the touch event on the other non-lightened screen display area; and

a display content adjustment unit, configured to control, according to the display instruction, the scrolling of the content displayed on the lightened screen display area; or to switch, according to the display instruction, the content displayed on the lightened screen display area.

As shown in FIG. 10, FIG. 10 is a block diagram of another display apparatus according to an example embodiment of the present disclosure. Given this embodiment, on the basis of the embodiment shown in FIG. 9, the display apparatus further includes:

a full-screen display module 33, configured, if a designated action of the user is detected, to lighten all the screen display areas to display the current content together.

For an implementation process of functions and effects of modules in the foregoing display apparatus, please refer to an implementation process of corresponding steps in the foregoing display method for details, which are not described herein again.

Because the apparatus embodiments basically correspond to the method embodiments, for related parts, reference may be made to a part of the description in the method embodiments. The apparatus embodiments described above are merely example. The modules described as separate parts may or may not be physically separate, and parts displayed as modules may or may not be physical modules, i.e., may be located in one position, or may be distributed on a plurality of network modules. Some or all of the modules may be selected according to actual needs to achieve the objectives of the solutions of the present disclosure. A person of ordinary skill in the art may understand and implement the embodiments of the present disclosure without involving creative efforts.

Accordingly, the present disclosure also provides a wearable device, including:

a processor;

a storage configured to store instructions executable by the processor; and

at least two touchable screen display areas;

wherein the processor is configured to perform operations in the display method as stated above.

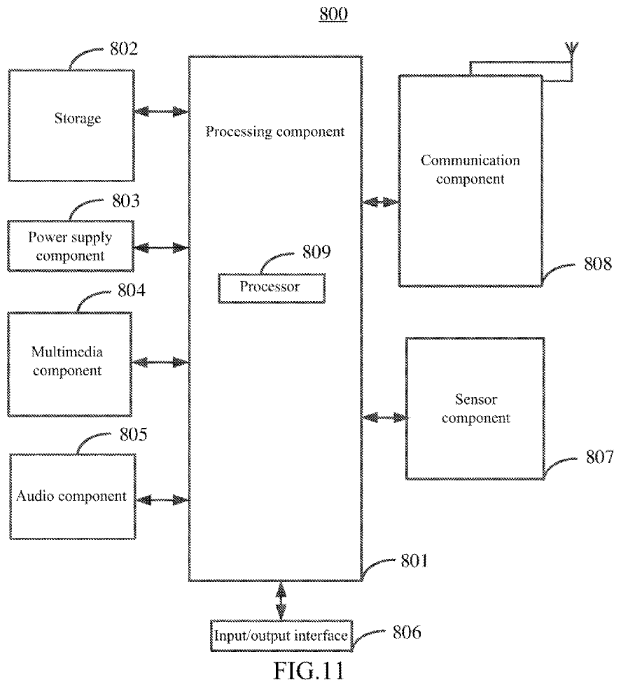

FIG. 11 is a schematic structural diagram of a wearable device to which a display apparatus is applied according to an example embodiment.

A shown in FIG. 11, a wearable device 800 according to an example embodiment is shown. The wearable device 800 may be a wearable device such as a bracelet, a watch, a wristband, a finger ring, an armband, or an ankle ring.

Referring to FIG. 11, the wearable device 800 may include one or more of the following components: a processing component 801, a storage 802, a power supply component 803, a multimedia component 804, an audio component 805, an Input/Output (I/O) interface 806, a sensor component 807, and a communication component 808.

The processing component 801 generally controls overall operations of the wearable device 800, such as operations associated with display, telephone calls, data communications, camera operations, and recording operations. The processing component 801 may include one or more processors 809 to execute instructions to implement all or some of the steps of the foregoing method. In addition, the processing component 801 may include one or more modules to facilitate interaction between the processing component 801 and other components. For example, the processing component 801 may include a multimedia module to facilitate interaction between the multimedia component 804 and the processing component 801.

The storage 802 is configured to store various types of data to support operations on the wearable device 800. Examples of the data include instructions for any application program or method operated on the wearable device 800, contact data, contact list data, messages, pictures, videos, and the like. The storage 802 may be implemented by any type of volatile or non-volatile storage device, or a combination thereof, such as a Static Random-Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk, or an optical disk.

The power supply component 803 provides power for various components of the wearable device 800. The power supply component 803 may include a power management system, one or more power supplies, and other components associated with power generation, management, and distribution for the wearable device 800.

The multimedia component 804 includes a screen that provides an output interface between the wearable device 800 and a user. In some embodiments, the screen may include a Liquid Crystal Display (LCD) and a Touch Panel (TP). If the screen includes a TP, the screen may be implemented as a touch screen to receive input signals from the user. The TP includes one or more touch sensors to sense touches, swipes, and gestures on the TP. The touch sensor may not only sense the boundary of a touch or swipe action, but also detect the duration and pressure related to the touch or swipe operation. In some embodiments, the multimedia component 804 includes a front camera and/or a rear camera. When the wearable device 800 is in an operation mode, such as, a photographing mode or a video mode, the front camera and/or the rear camera may receive external multimedia data. Each of the front camera and the rear camera may be a fixed optical lens system, or have a focal length and an optical zoom capability.

The audio component 805 is configured to output and/or input an audio signal. For example, the audio component 805 includes a microphone (MIC), and when the wearable device 800 is in an operation mode, such as a calling mode, a recording mode, and a voice recognition mode, the microphone is configured to receive an external audio signal. The received audio signal may be further stored in the storage 802 or transmitted by means of the communication component 808. In some embodiments, the audio component 805 further includes a speaker for outputting the audio signal.

The I/O interface 806 provides an interface between the processing component 801 and a peripheral interface module, which may be a keyboard, a click wheel, a button, or the like. The button may include, but is not limited to, a home button, a volume button, a start button, and a lock button.

The sensor component 807 includes one or more sensors for providing state assessment in various aspects for the wearable device 800. For example, the sensor component 807 may detect an on/off state of the wearable device 800, and relative positioning of components. For example, the components are the display and keypad of the wearable device 800. The sensor component 807 may further detect a position change of the wearable device 800 or a component of the wearable device 800, the presence or absence of contact of the user with the wearable device 800, the orientation or acceleration/deceleration of the wearable device 800, and a temperature change of the wearable device 800. The sensor component 807 may include a proximity sensor, which is configured to detect the presence of a nearby object without any physical contact. The sensor component 807 may further include a light sensor, such as a CMOS or CCD image sensor, for use in an imaging application. In some embodiments, the sensor component 807 may further include an acceleration sensor, a gyroscope sensor, a magnetic sensor, a pressure sensor, a heart rate signal sensor, an electrocardiography sensor, a fingerprint sensor, or a temperature sensor.

The communication component 808 is configured to facilitate wired or wireless communications between the wearable device 800 and other devices. The wearable device 800 may access a wireless network based on a communication standard, such as WiFi, 2G, or 3G, or a combination thereof. In an example embodiment, the communication component 808 receives a broadcast signal or broadcast-related information from an external broadcast management system by means of a broadcast channel. In an example embodiment, the communication component 808 further includes a Near Field Communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In an example embodiment, the wearable device 800 may be implemented by one or more Application-Specific Integrated Circuits (ASICs), Digital Signal Processors (DSPs), Digital Signal Processing Devices (DSPDs), Programmable Logic Devices (PLDs), Field-Programmable Gate Arrays (FPGAs), controllers, microcontrollers, microprocessors, or other electronic components, to execute the foregoing method.

In an example embodiment, a non-transitory computer-readable storage medium including instructions is also provided, such as a storage 802 including instructions. The instructions are executable by the processor 809 of the wearable device 800 to implement the foregoing method. For example, the non-transitory computer-readable storage medium may be a ROM, a random access memory (RAM), a CD-ROM, a magnetic tape, a floppy disk, an optical data storage device, and the like.

The instructions in the storage medium are executed by the processor 809, the wearable device 800 is enabled to perform the foregoing display method.

Other embodiments of the present disclosure will be apparent to a person skilled in the art from consideration of the specification and practice of the invention disclosed herein. The present disclosure is intended to cover any variations, functions, or adaptive changes of the present disclosure. These variations, uses, or adaptive changes comply with general principles of the present disclosure, and include common knowledge or a customary technical means in the technical field that is not disclosed in the present disclosure. The specification and the embodiments are merely considered to be example, and the actual scope and spirit of the present disclosure are pointed out by the following claims.

It should be understood that the present disclosure is not limited to the exact structure that has been described above and illustrated in the accompanying drawings, and that various modifications and changes can be made without departing from the scope thereof. The scope of the present disclosure is only defined by the appended claims.

The above descriptions are merely preferred example embodiments of the present disclosure, but are not intended to limit the present disclosure. Any modification, equivalent replacement, or improvement made without departing from the spirit and principle of the present disclosure shall fall within the protection scope of the present disclosure.

What is claimed is:

1. A display method for a wearable device comprising at least two touch screen display areas, the display method comprising:
displaying current content on a first screen display area that has been turned on; and
adjusting the current content displayed on the first screen display area according to a touch event on a second screen display area that has not been turned on, wherein the at least two touch screen display areas comprise the first screen display area and the second screen display area.

2. The display method according to claim 1, wherein positions of the first screen display area and the second screen display area satisfy that: when a user wears the wearable device, the first screen display area and the second screen display area are not located on the same plane simultaneously.

3. The display method according to claim 2, wherein the wearable device further comprises an inertial sensor; and
wherein the display method further comprises:
before turning on the first screen display area:
determining a target action of the user according to data collected by the inertial sensor; and
determining, according to the target action, a screen display area corresponding to a sight range of the user from the at least two touch screen display areas as the first screen display area.

4. The display method according to claim 3, further comprising:
determining a display direction of the current content according to the target action, and adjusting the current content based on the display direction, the display direction being a horizontal direction or a vertical direction.

5. The display method according to claim 2, wherein the wearable device further comprises at least two audio collection units corresponding to the at least two touch screen display areas; and
wherein the display method further comprises:
before turning on the first screen display area, determining an audio collection unit nearest to a sound source according to voice signals collected by all the at least two audio collection units, so as to determine a corresponding screen display area as the first screen display area.

6. The display method according to claim 1, wherein the wearable device further comprises an electromyography sensor; and
wherein the display method further comprises:
in response to the data collected by the electromyography sensor meeting a preset condition, turning on the first screen display area, the preset condition comprising data representing that a current action of a user is a clenching action.

7. The display method according to claim 1, further comprising:
while turning on the first screen display area, activating the second screen display area that has not been turned on.

8. The display method according to claim 1, further comprising:
when multiple touch events are received, processing the multiple touch events in sequence based on preset touch event response priorities of the at least two touch screen display areas, so as to adjust the current content displayed on the first screen display area, the touch events comprising events triggered on all of the at least two touch screen display areas.

9. The display method according to claim 1, wherein the touch event comprises at least one of: a sliding event, a tap event, or a long press event.

10. The display method according to claim 1, wherein the adjusting the current content displayed on the first screen display area comprises:
controlling scrolling of the content displayed on the first screen display area; or
switching the content displayed on the first screen display area.

11. The display method according to claim 1, further comprising:
in case a designated action of a user is detected, turning on all the screen display areas to display the current content together.

12. A wearable device, wherein the wearable device comprises:
a processor;
a storage configured to store instructions executable by the processor; and
at least two touchable screen display areas;
wherein the processor is configured to perform the display method according to claim 1.

13. The wearable device according to claim 12, wherein positions of the first screen display area and the second screen display area satisfy that: when a user wears the wearable device, the first screen display area and the second screen display area are not located on the same plane simultaneously.

14. The wearable device according to claim 13, wherein the wearable device further comprises an inertial sensor; and
wherein the display method further comprises:
before turning on the first screen display area:
determining a target action of the user according to data collected by the inertial sensor; and
determining, according to the target action, a screen display area corresponding to a sight range of the user from the at least two touch screen display areas as the first screen display area.

15. The wearable device according to claim 13, wherein the wearable device further comprises at least two audio collection units corresponding to the at least two touch screen display areas; and
wherein the display method further comprises:
before turning on the first screen display area, determining an audio collection unit nearest to a sound source according to voice signals collected by all the at least two audio collection units, so as to determine a corresponding screen display area as the first screen display area.

16. The wearable device according to claim 12, wherein the wearable device further comprises an electromyography sensor; and
wherein the display method further comprises:
in response to the data collected by the electromyography sensor meeting a preset condition, turning on the first screen display area, the preset condition comprising data representing that a current action of a user is a clenching action.

17. The wearable device according to claim 12, further comprising:
while turning on the first screen display area, activating the second screen display area that has not been turned on.

18. The wearable device according to claim 12, further comprising:
when multiple touch events are received, processing the multiple touch events in sequence based on preset touch event response priorities of the at least two touch screen display areas, so as to adjust the current content displayed on the first screen display area, the touch events comprising events triggered on all of the at least two touch screen display areas.

19. A non-transitory computer-readable storage medium having a computer program stored thereon, which, when executed by one or more processors, causes the processors to perform the display method according to claim 1.

20. The non-transitory computer-readable storage medium of claim 19, wherein positions of the first screen display area and the second screen display area satisfy that: when a user wears the wearable device, the first screen display area and the second screen display area are not located on the same plane simultaneously;
wherein the wearable device further comprises an inertial sensor; and
wherein the display method further comprises:
before turning on the first screen display area:
determining a target action of the user according to data collected by the inertial sensor; and
determining, according to the target action, a screen display area corresponding to a sight range of the user from the at least two touch screen display areas as the first screen display area.
